(19) United States
(12) Patent Application Publication
(10) Pub. No.: US 2004/0091417 A1
(43) Pub. Date: May 13, 2004

(54) Nanotechnology for agriculture, horticulture, and pet care

(75) Inventor: Tapesh Yadav, Longmont, CO (US)

Correspondence Address: FOLEY AND LARDNER, SUITE 500, 3000 K STREET NW, WASHINGTON, DC, 20007, US

(73) Assignee: NanoProducts Corporation

(21) Appl. No.: 10/702,484

(22) Filed: Nov. 7, 2003

Related U.S. Application Data
(60) Provisional application No. 60/424,582, filed on Nov. 7, 2002.

(51) Int. Cl. C01G 1/00

(52) U.S. Cl. 423/592.1

(57) ABSTRACT

Nanomaterials are disclosed for the applications of nanotechnology to agriculture, horticulture, aquaculture, pet care and other areas.

### RELATED APPLICATIONS

The present application claims the benefit of provisional application No. 60/424,582 filed Nov. 07, 2002, which application is hereby incorporated by reference in its entirety.

### BACKGROUND OF THE INVENTION

1. Field of the Invention

The present invention relates, in general, to nanoscale powders, and, more particularly, to substances and methods to reduce the adverse losses from pests, weeds, and disease causing organisms in agriculture, horticulture, aquaculture, recreational gardening, pet care and other applications.

2. Relevant Background

Powders are used in numerous applications. They are the building blocks of electronic, telecommunication, electrical, magnetic, structural, optical, biomedical, chemical, thermal, and consumer goods. On-going market demand for smaller, faster, superior and more portable products have demanded miniaturization of numerous devices. This, in turn, has demanded miniaturization of the building blocks, i.e., the powders. Sub-micron and nano-engineered (or nanoscale, nanosize, ultrafine) powders, with a size 10 to 100 times smaller than conventional micron size powders, enable quality improvement and differentiation of product characteristics at scales currently unachievable by commercially available micron-sized powders.

Nanopowders in particular and sub-micron powders in general are a novel family of materials whose distinguishing feature is that their domain size is so small that size confinement effects become a significant determinant of the materials'performance. Such confinement effects can, therefore, lead to a wide range of commercially important properties. Nanopowders, therefore, are an extraordinary opportunity for design, development and commercialization of a wide range of devices and products for various applications. Furthermore, since they represent a whole new family of material precursors where conventional coarse-grain physiochemical mechanisms are not applicable, these materials offer unique combination of properties that can enable novel and multifunctional components of unmatched performance. Yadav et al. in a co-pending and commonly assigned U.S. patent application Ser. No. 09/638,977 which along with the references contained therein are hereby incorporated by reference in full, teach some applications of sub-micron and nanoscale powders.

Pests, weeds, insects, molds, bacteria and other damaging agents adversely impact the health and growth of various flora and fauna. Significant effort has been made to develop organic chemicals that selectively stop, reduce, or prevent the damage caused by such damaging agents to agriculture, horticulture, aquaculture, recreational gardens, pets, and property. However, chemicals also have a tendency to enter into ecosystems and cause undesirable ecological and environmental effects. Technologies are desired that can reduce the use of organic chemicals while ensuring that the damaging effects of pests, weeds, and other agents are checked or prevented.

Another limitation of current technology based on the use of organic chemicals is the ineffective use of dosage. Often, the concentration of the dosage when it is first applied is very high which then rapidly dwindles. Such an application provides more than a desired concentration immediately after application and then too low of the desired concentration after several days of the application. It is preferred in many cases that a more uniform and continuous protection from pests, weeds, etc. be available. Current technologies are unable to offer this.

### Definitions

Fine powders, as the term used herein, are powders that simultaneously satisfy the following:

1. particles with mean size less than 100 microns, and

2. particles with aspect ratio between 1 and 1,000,000.

For example, in some embodiments the fine powders are powders that have particles with a mean size less than 10 microns and with an aspect ratio ranging from 1 to 1,000,000.

Submicron powders, as the term used herein, are fine powders that simultaneously satisfy the following:

1. particles with mean size less than 1 micron, and

2. particles with aspect ratio between 1 and 1,000,000.

Nanopowders (or nanosize or nanoscale powders or nanoparticles), as the term used herein, are fine powders that simultaneously satisfy the following:

1. particles with mean size less than 250 nanometers, and

2. particles with aspect ratio between 1 and 1,000,000.

For example, in some embodiments, the nanopowders are powders that have particles with a mean size less than 100 nanometers and with an aspect ratio ranging from 1 to 1,000,000.

Pure powders, as the term used herein, are powders that have composition purity of at least 99.9% by metal basis. For example, in some embodiments the purity is 99.99%.

Powder, as the term used herein, encompasses oxides, carbides, nitrides, chalcogenides, metals, alloys, and combinations thereof. The term includes hollow, dense, porous, semi-porous, coated, uncoated, layered, laminated, simple, complex, dendritic, inorganic, organic, elemental, non-elemental, composite, doped, undoped, spherical, non-spherical, surface functionalized, surface non-functionalized, stoichiometric, and non-stoichiometric form or substance.

Active ingredients, as the term used herein, encompasses any inorganic, organic, metallic, alloy, protein, genetic or nucleic material, antigen or antibody, composite, formulated or comprising ingredient that affects or participates in the physiology of a fauna or flora or micro-organisms residing in or with or on the fauna or flora when the ingredient is applied or delivered by any means to the fauna or flora in any shape, form or manner.

Essential nutrients, as the term used herein, includes one or more essential micronutrients and macronutrients, such as but are not limited to, Cu, Zn, K, Ca, Fe, Mg, Mn, Co, and Na.

### SUMMARY OF THE INVENTION

Briefly stated, the present invention describes the processes and products for encouraging growth of flora and fauna and inhibiting disease in flora and fauna. The invention describes nanomaterials enabled technologies for enhancing the quality of agriculture, horticulture, aquaculture, gardens and pets. Disclosed are nanoscale powders, methods of their application, and products enabled by nanotechnology.

### BRIEF DESCRIPTION OF THE DRAWINGS

FIG. 1 shows an exemplary overall approach for producing fine powders in accordance with the present invention.

### DETAILED DESCRIPTION OF THE PREFERRED EMBODIMENTS

This invention is generally directed to the production and application of very fine powders of oxides, carbides, nitrides, borides, chalcogenides, metals, and alloys. In some embodiments, the scope of this invention includes high purity powders which are powders with purity higher than 99.99% by metal content. The powders can be produced and processed by any method including but not limiting to the methods taught by commonly owned patents U.S. Pat. Nos. 5,788,738, 5,851,507, and 5,984,997 each of which patents are hereby incorporated by reference in its entirety.

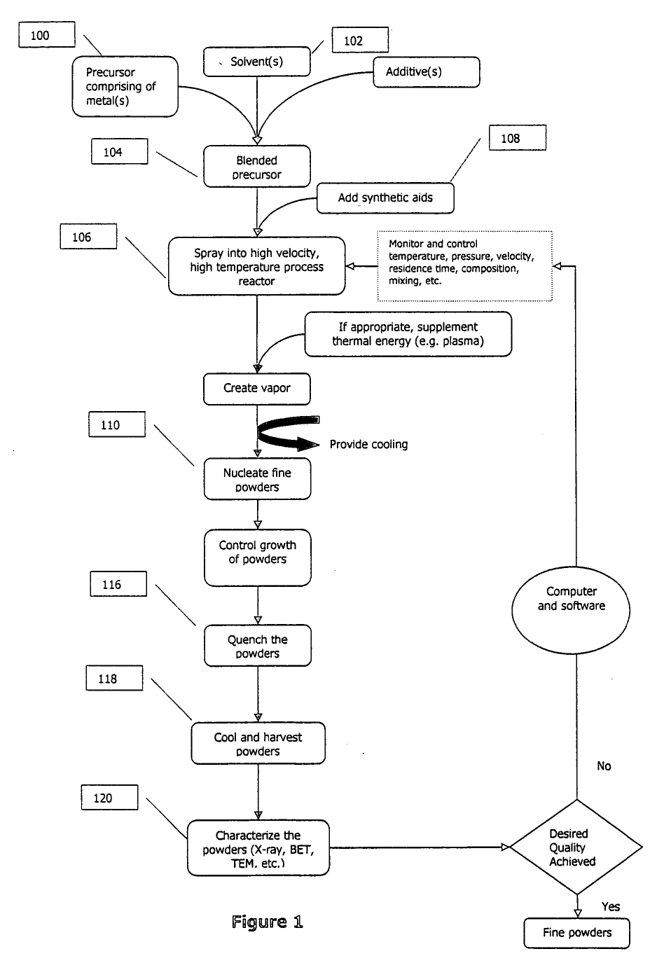

FIG. 1 shows an exemplary overall approach for the production of submicron powders in general and nanopowders in particular. The process shown in FIG. 1 begins with a raw material (for example but not limiting to coarse oxide powders, metal powders, salts, slurries, sols, emulsions, waste product, organic compound or inorganic compound). FIG. 1 shows one embodiment of a system for producing nanoscale and submicron powders in accordance with the present invention.

The process shown in FIG. 1 begins at 100 with a metal-containing precursor such as an emulsion, fluid, particle-containing liquid slurry, or water-soluble salt. The precursor may be evaporated metal vapor, evaporated alloy vapor, a gas, a single-phase liquid, a multi-phase liquid, a melt, a sol, a solution, fluid mixtures, or combinations thereof. The metal-containing precursor comprises a stoichiometric or a non-stoichiometric metal composition with at least some part in a fluid phase. Fluid precursors are preferred in this invention over solid precursors because fluids are easier to convey, evaporate, and thermally process, and the resulting product is more uniform. Nevertheless, solid precursors may also be used according to the present invention.

In one embodiment of this invention, the precursors are environmentally benign, safe, readily available, high-metal loading, lower cost fluid materials. Examples of metal-containing precursors suitable for purposes of this invention include, but are not limited to, metal acetates, metal carboxylates, metal ethanoates, metal alkoxides, metal octoates, metal chelates, metallo-organic compounds, metal halides, metal azides, metal carbonates, metal hydroxides, metal nitrates, metal sulfates, metal hydroxides, metal salts soluble in organics or water, and metal-containing emulsions.

In another embodiment, multiple metal precursors may be mixed if complex nanoscale and submicron powders are desired. For example, a silver precursor, a zinc precursor and a tin precursor may be mixed to prepare silver tin zinc oxide powders. As another example, a palladium precursor, ruthenium precursor, and copper precursor may be mixed in correct proportions to yield a high purity powder three metal comprising nanoparticle. In another embodiment, a solvent is added to the metal comprising precursor in order to modify the flow properties of the precursor or to change the particle characteristics.

In all embodiments of this invention, it is desirable to use precursors of a higher purity to produce a nanoscale or submicron powder of a desired purity. For example, if purities greater than x % (by metal weight basis) is desired, one or more precursors that are mixed and used have purities greater than or equal to x % (by metal weight basis) to practice the teachings herein.

With continued reference to FIG. 1, the metal-containing precursor 100 (containing one or a mixture of metal-containing precursors) is fed into a high temperature process 106 implemented using a high temperature reactor, for example. In one embodiment, a synthetic aid such as a reactive fluid 108 can be added along with the precursor 100 as it is being fed into the reactor 106. Examples of such reactive fluids include, but are not limited to, oxygen gas and air.

While the above examples specifically teach methods of preparing nanoscale and submicron powders of oxides, the teachings may be readily extended in an analogous manner to other compositions such as carbides, nitrides, borides, carbonitrides, and chalcogenides. In one embodiment, high temperature processing may be used. Nevertheless, a moderate temperature processing or a low/cryogenic temperature processing may also be employed to produce nanoscale and submicron powders.

The precursor 100 may be also pre-processed in a number of other ways before the high temperature thermal treatment. For example, the pH may be adjusted to ensure stable precursor. Alternatively selective solution chemistry such as precipitation may be employed to form a sol or other state of matter. The precursor 100 may be pre-heated or partially combusted before the thermal treatment.

The precursor 100 may be injected axially, radially, tangentially, or at any other angle into the high temperature region 106. As stated above, the precursor 100 may be pre-mixed or diffusionally mixed with other reactants. The precursor 100 may be fed into the thermal processing reactor by a laminar, parabolic, turbulent, pulsating, sheared, or cyclonic flow pattern, or by any other flow pattern. In addition, one or more metal-containing precursors 100 can be injected from one or more ports in the reactor 106. The feed spray system may yield a feed pattern that envelops the heat source or, alternatively, the heat sources may envelop the feed, or alternatively, various combinations of this may be employed. In one embodiment, the feed is atomized and sprayed in a manner that enhances heat transfer efficiency, mass transfer efficiency, momentum transfer efficiency, and reaction efficiency. For example, the feed is sprayed with a gas wherein the gas velocities is maintained between 0.05 mach to 10 mach. The reactor shape may be cylindrical, spherical, conical, or any other shape. Methods and equipment such as those taught in U.S. Pat. Nos. 5,788,738, 5,851,507, and 5,984,997 (each of which patents are incorporated herein by reference in its entirety) can be employed in practicing the methods of this invention.

With continued reference to FIG. 1, after the precursor 100 has been fed into reactor 106, it is processed at high temperatures to form the product powder. In one embodiment, the thermal treatment is done in a gas environment with the aim to produce a product such as powders that have a desired porosity, density, morphology, dispersion, surface area, and composition. This step produces by-products such as gases. To reduce costs, these gases may be recycled, mass/heat integrated, or used to prepare the pure gas stream desired by the process.

In some embodiments, the high temperature processing is conducted at step 106 (FIG. 1) at temperatures greater than 1500 K. In other embodiments, the temperature is greater than 2500 K. In other embodiments, the temperature is greater than 3000 K. In other embodiments, the temperature is greater than 4000 K. Such temperatures may be achieved by various methods including, but not limited to, plasma processes, combustion, pyrolysis, electrical arcing in an appropriate reactor, and combinations thereof. The plasma may provide reaction gases or just provide a clean source of heat.

With continued reference to FIG. 1., the high temperature process 106 results in a vapor comprising the elements in the precursor. After the thermal processing, this vapor is cooled at step 110 to nucleate submicron powders, preferably nanopowders. In some embodiments, the cooling temperature at step 110 is high enough to prevent moisture condensation. The dispersed particles form because of the thermokinetic conditions in the process. By engineering the process conditions such as pressure, residence time, supersaturation and nucleation rates, gas velocity, flow rates, species concentrations, diluent addition, degree of mixing, momentum transfer, mass transfer, and heat transfer, the morphology of the nanoscale and submicron powders can be tailored. It is worth noting that the focus of the process should be on producing a powder product that excels in satisfying the end application requirement and customer needs.

After cooling, the nano-dispersed powder may be quenched to lower temperatures at step 116 to minimize and optionally to prevent agglomeration or grain growth. Suitable quenching methods include, but are not limited to, methods taught in U.S. Pat. No. 5,788,738 which is hereby incorporated by reference in its entirety. Sonic to supersonic quenching methods may be used in practicing the invention. In one embodiment, quenching methods may be employed which can prevent deposition of the powders on the conveying walls. These methods may include electrostatic means, blanketing with gases, the use of higher flow rates, pneumatic means, mechanical means, chemical means, electrochemical means, or sonication/vibration of the walls.

In one embodiment, the high temperature processing system includes instrumentation and software that can assist in the quality control of the process. Furthermore, in some embodiments, the high temperature processing zone 106 is operated to produce fine powders 120 (FIG. 1). In other embodiments, the high temperature processing zone 106 is operated to produce submicron powders. In other embodiments, the high temperature processing zone 106 is operated to produce nanopowders. The gaseous products from the process may be monitored for composition, temperature and other variables to ensure quality at 112 (FIG. 1). The gaseous products may be recycled to be used in process 108 (FIG. 1), or used as a valuable raw material when nanoscale and submicron powders 120 have been formed, or they may be treated to remove environmental pollutants if any. Following quenching step 116 (FIG. 1) the nanoscale and submicron powders are cooled further at step 118 and then harvested at step 120.

The product nanoscale and submicron powders 120 may be collected by any method. Suitable collection means include, but are not limited to, bag filtration, electrostatic separation, membrane filtration, cyclones, impact filtration, centrifugation, hydrocyclones, thermophoresis, magnetic separation, and combinations thereof. In one embodiment, a cake of the nanopowder is formed on the collection media, which then acts as an efficient collector capable of collecting with an efficiency greater than 95%. For example, in some embodiments, the efficiency is greater than 99%.

The quenching at step 116 may be modified to enable preparation of coatings. In this embodiment, a substrate may be provided (in batch or continuous mode) in the path of the quenching powder containing gas flow. By engineering the substrate temperature and the powder temperature, a coating comprising the submicron powders and nanoscale powders can be formed.

A coating, film, or component may also be prepared by dispersing the fine nanopowder and then applying various known methods such as, but not limiting to, electrophoretic deposition, magnetophoretic deposition, spin coating, dip coating, spraying, brushing, screen printing, ink-jet printing, toner printing, and sintering. The nanopowders may be thermally treated or reacted to enhance its properties before such a step.

It should be noted that the intermediate or product at any stage, or similar process based on modifications by those skilled in the art, may be used directly as feed precursor to produce nanoscale or fine powders by methods such as, but not limiting to, those taught in commonly owned U.S. Pat. Nos. 5,788,738, 5,851,507, 5,984,997, and co-pending applications 09/638,977 and 60/310,967 which are all incorporated herein by reference in their entirety. For example, a sol may be blended with a fuel and then utilized as the feed precursor mixture for thermal processing above 2500 K to produce nanoscale simple or complex powders.

The motivating features that make nanoscale particles particularly useful for the agriculture, horticulture, aquaculture, pets and other forms of flora and fauna are several.

First, the size of the particles is smaller than most cells, and in some cases nanoparticles are smaller than the pores in a cell membrane. The small size can enable facile delivery and absorption of the particles into the cells.

Second, the high surface area of the nanoscale particles can accelerate those physiological processes that depend on the surface area of the particles. For example, dissolution kinetics of nutrients and surface interaction kinetics in the case of pesticides. It is important to note that the surface of the nanoparticles needs to be clean and non-agglomerated. It is preferred that the nanoparticles be discrete and non-agglomerated. The insight and resultant surprising capability enabled by the ultra-fine grain size of nanostructured materials is as follows—the change in free energy of a particle is composed of change in volume-related free energy and the change in surface-related free energy. The volume related free energy is a result of the energy release as bonds form between atoms that constitute the particle. The surface related free energy is a result of the energy change when surface atoms dissolve into the liquid or medium, or they solvate by forming free energy reducing bonds with the liquid or medium. As nanoparticles are confined to smaller and smaller sizes, the surface tension-related energy becomes more and more significant part of total thermodynamic free energy for the substance. At a particular nanoparticle size, herewith called the nano-solvation diameter, the change in free energy with changing size becomes zero. Thereafter, further reduction in particle size is thermodynamically favored, and the nanoparticle begins to dissolve into the medium. For active ingredients, drug and antimicrobial delivery, this is the regime one must strive for and nanotechnology taught herein enables one to do that. More specifically, this nano-solvation diameter can be given by:

δₚ=ΔGₛ/ 3*ΔGᵥ

where:

δₚ=critical nano-solvation diameter (nanoparticle size); (meters)

ΔGₛ=surface tension (J/m²)

ΔGᵥ=free energy gain through bond formation per unit volume (J/m³);

In some embodiments, the nano-solvation diameter is calculated and the particles are engineered to a size below the nano-solvation diameter. In some embodiments, where there is an absence of such calculation, the particle size may be less than 85 nanometers. In some embodiments, the particle size may be less than 40 nanometers. And in some embodiments, the particle size may be less than 10 nanometers. If time release characteristics are sought, it is equally important that the particle size be not too small as the dissolution rate is faster with smaller and smaller particles. For time release applications, in some embodiments, the particle sizes be engineered such that they have particle size distribution as follows—D₂₅>0.25* δₚ and D₇₅<δₚ; in some embodiments, they have particle size distribution as follows—D₀₁>0.25* δₚ and D₉₉<δₚ. Atomic disorder and crystalline defects that increase the interfacial area of nanoparticles, but do not increase the “available surface area” of nanoparticles are not preferred for teachings in this application. Atomically ordered, non-agglomerated nanoparticles are preferred herein. The term “available surface area” means that surface area of particle that is available for interaction with media or another substance. The available surface area of nanoparticles can be measured, as first approximation, to be the BET surface area using instruments manufactured by companies such as Coulter®, Micromeritics® and Quantachrome®. While these teachings can be employed to all partially soluble substances, these teachings are even more valuable when the inherent solubility of an organic or inorganic active, medicine, drug, pharmaceutical, nutrient is low to very low in the desired medium. Nanotechnology products prepared using teachings above can be used to provide effective delivery dosage, care and cure. Furthermore, this can reduce the cost of the nurture and care.

Third benefit of nanotechnology is that with post-processing of nanoparticles with methods such as those taught by us in commonly owned patent application U.S. patent application Ser. No. 10/113315, which is hereby incorporated in full by reference, nanoparticles can be used to more homogeneously and effectively distribute the target substance to the flora or fauna. In other words, large particles inherently provide too large a dosage non-uniformly. Finer particles can be more uniformly distributed over more surface area or volume. This can make the target substance more effective. This can also reduce the amount needed to achieve same performance. The ability to uniformly load the target substance improves the performance of the target substance. It also prevents waste and environmental or ecological damage from wash off of target substance such as pesticides.

Fourth, with post-processing of nanoparticles with methods such as those taught by us in commonly owned patent applications, time release or slow release of target substances (such as nutrients or pesticides) at a suitable rate can be accomplished. Such time release or slow release can improve the efficacy of the target substance as the dosage can then be engineered to meet the required levels. Furthermore, this can also reduce the number of applications necessary and thereby reduce the cost of application of the target substance to the flora or fauna. Effective use of the target substance can also reduce the volume of target substance required and therefore the cost of the treatment. Finally, the effective use can also significantly reduce the run off of the target substance into ground water or natural rain water streams or other environmental systems.

Fifth, nanoparticles offer unusual properties such as, but not limiting to, surface chemical potential. It is well known to those in the art that certain substances in solid phase act as pesticides and inhibit the growth of bacteria and other damage causing agents. In nanoparticles form, novel chemical potentials of the surface and the size confinement effects can create substances that provide effective and continuous protection against damage causing agents. This capability contrasts well with liquids and gaseous forms of target substances that only provide temporary relief as they run-off or degrade in the environment. Furthermore, with nanoparticulate compositions such as those based on copper, zinc, silver, iron, and others elements, products can be developed that prevent disease by design.

### Nutrient Delivery

In one embodiment, fine powders or nanoscale powders are produced of a composition that provide macronutrients and/or micronutrients to flora and/or fauna of interest. For example, submicron powders and more preferably nanoparticles of potassium compounds or phosphorus containing compounds or nitrogen containing compounds can be prepared and applied to plants. The application can be done to roots, leaves, or other plant parts. The application may be accomplished using a dry or wet spray system; however other techniques may also be used. Similarly for pets or aquaculture, micronutrient containing compounds may be formulated as submicron powders or nanoscale powders and then used.

In a further embodiment, flora or fauna diagnosed to be unhealthy or diseased are treated with nano-engineered nutrients. The advantage of nanostructured nutrients is in their rapid and easy absorption and broad near-uniform distribution while ensuring that material is not wasted.

In another emobodiment, soil or inert plant material is mixed with nanoparticulate nutrients and then applied.

In yet another embodiment, nutrient nanocomposites or nanomaterials are applied in combination with a sensor. This comprises the following steps—(a) the nutrient state of flora or fauna is optically, chemically, ultrasonically, and/or electrochemically measured, (b) this measurement is compared against the preferred or desired state and appropriate dosage of nutrient is determined based on this comparison, (c) the dosage is metered from nanoscale or submicron nutrient or other materials, (d) the metered dosage is then applied to the flora and fauna. The metering can be done in water media or in solid form or in any fluid form. This testing and application of nano-nutrients can be automated and controlled using a computer.

### Time Release Delivery

In one embodiment of this invention, fungicides, herbicides, pesticides, insecticides, medicines, nutrients and other chemicals are delivered to flora and fauna in a time release manner that maximizes the beneficial use of said chemical. This can reduce waste and undesired side effects to the ecology and environment. The reduced waste results in cost reduction.

Time release can be accomplished through passive means, e.g. by mixing the desired chemical with inerts such as silica or soil into a composite and then applying the said composite. The degree of mixing and the concentration of the desired chemical in the inert material is anticipated to affect the dissolution and diffusion rate of the desired chemical from the said composite.

Time release of nutrients, single or complex combination of nutrients, can also be applied through active means, e.g. timed release controlled by means of a software.

### Damage Prevention and Control

Nanoparticles can also be employed to selectively deliver pesticides, herbicides, algaecides, fungicides, and mold-controlling chemicals and species. The advantage of using nanoparticles is targeted delivery and assimilation through the pores of the source. In case of pet care, the nanoparticles with preferred size less than 100 nm, more preferably less than 50 nm and even more preferably less than 25 nm can be utilized to transport health care pharmaceuticals, drugs and minerals directly through the skin. While the nanoparticles may be organic or inorganic, the preferred embodiment of this invention is to employ nanoparticles comprising of inert inorganic materials. Such a method of drug or nutrient delivery is expected to be particularly useful when the other methods of feed mechanism is difficult or ineffective.

### Reduction of Mold Growth Inside Pipes

Nanoparticles can also be employed to prevent the growth of molds and other undesirable pest through the use of a thin coating of nanoparticles of biocide inorganic or organic species. The coating can be formed by dip coating, electrochemical deposition, thermal spray, screen printing, chemical precipitation, or any other technique. The advantage of nanotechnology here is its ability to achieve prevention effectiveness with lower levels of biocides. Another advantage is the achievement of higher surface activity of the biocide because of size confinement effects.

### EXAMPLE 1

### Copper Oxide and Copper Nanomaterials

99.5%+pure Copper Cem-All® from OM Group Inc. was diluted with hexane till the viscosity of the mixture was less than 20 cP. The precursor mix was then combusted in 99% pure oxygen in the presence of thermal plasma in a reactor operating at about 0.5-0.7 atmospheres. The maximum feed velocity and gas processing velocities were above 0.1 mach and the peak processing temperatures were above 3200 K. The vapor was cooled to nucleate nanoparticles and then quenched using Joule Thompson effect as taught in co-owned U.S. Pat. No. 5,788,738. The powders were collected on a conductive polymer membrane filtration system. The collected powders were analyzed and were found to have a X-ray crystallite size less than 50 nanometers and a surface area greater than 20 m²/gm. This example illustrates that copper oxide nanoparticles can be successfully prepared. Copper oxide nanoparticles are useful in agriculture and as a fungicide, algicide and antimicrobial. Similarly, copper oxide nanoparticles are an effective source of copper, an essential micronutrient mineral for pets. For use as a pet micronutrient source, the non-copper impurities in the precursor raw materials need to be reduced to standards established in the art, such as the USP.

Copper oxide nanoparticles produced above were next reduced in a stream of reducing gas (5% hydrogen in nitrogen, other gas compositions can be used). This yielded copper metal nanoparticles as confirmed by x-ray diffractometry. Copper nanoparticles are also useful in applications described above.

### EXAMPLE 2

Silver and Silver Oxide Nanoparticles

A hundred liter raw material batch was prepared by mixing 18.4 kgs of silver nitrate (>99.9% purity) into 48 kgs of demineralized water. Next 40 kgs of isopropyl alcohol was added to the silver nitrate dissolved in the water. This yielded about 100 liters of silver comprising raw material. The silver comprising precursor mix was then combusted in 99%+pure oxygen in the presence of argon-based DC thermal plasma in a reactor operating between about 0.1-0.75 atmospheres. The maximum feed velocity and gas processing velocities were above 0.1 mach and the peak processing temperatures were above 3200 K. The vapor was cooled to nucleate nanoparticles and then quenched using Joule Thompson effect as taught in co-owned U.S. Pat. No. 5,788,738. The powders were collected on a conductive polymer membrane filtration system. The collected powders were analyzed and were found to be pure silver and have a X-ray crystallite size less than 40 nanometers and a surface area greater than 2 m²/gm. The powder was examined under high resolution transmission electron microscope and was observed to be non-amorphous and it lacked atomic disorder. A thermogravimetric study indicated that the silver particles had undetectable weight loss suggesting that the surface was clean. This example illustrates that surface-clean silver nanoparticles can be successfully prepared.

This example offers some surprising contrast with other teachings such as those of Burell et al. in U.S. Pat. No. 5,681,575, which is hereby incorporated in full by reference. Burell et al. teach that it is necessary to use silver with sufficient atomic disorder for antimicrobial activity. Burell et al. teach that atomic disorder and point defects should be engineered into crystals by techniques such as vacuum deposition, cold working, sputtering for anti-microbial activity. In contrast, we surprisingly find that silver nanoparticles without artificially induced point defects and atomic disorder can be effective antimicrobials if they have clean surfaces and maintain a domain size less than 100 nanometers. In more optimized systems, silver nanoparticles sizes may be further reduced to a size preferably less than 50 nanometers, more preferably less than 25 nanometers and most preferably less than 10 nanometers. It is important to note that the concept of artificially induced atomic disorder is important because making perfect crystals with no defects is kinetically difficult and in practical sense, thermodynamically prohibited. Nature favors an equilibrium level of thermodynamic defects in crystals for a given processing state. Burell et al. teach that artificial point defects and atomic disorder in silver nanomaterials (and other metals) for antimicrobial performance. We teach a new class of antimicrobials wherein the beneficial properties of, e.g., silver are obtained from non-agglomerated discrete nanomaterials synthesized with clean surface and without artificially created atomic disorder inside the domain of each nanoparticle. This insight can be extended to other elements for applications taught herein, illustrative elements include—Cu, Zn, Au, Pt, Pd, Ir, Ru, V, Ca, K, Na, Sn, Sb, Bi, and rare earths or alloys or compounds or composites containing one or more of these elements. It is preferred that the elemental composition of the actives in the nanoparticle be greater than 95%, preferably greater than 99%, more preferably greater than 99.9% and most preferably greater than 99.95%.

The silver nanoparticle produced above was dispersed in water to yield a grayish-black dispersion that was stable. This dispersion can be used as nano-ink.

Silver nanoparticles with high available surface area produced using the methods above and broader teachings herein are excellent broadband anti-microbials, anti-fungal, anti-bacterial agent. They can applied as coatings or additives or in creams or as part of bandages to treat infected parts or wounds to prevent infection.

### EXAMPLE 3

### Zinc Oxide Nanoparticles

Zinc octoate (>99.5% purity) from Shepard Chemicals was mixed with hexane from Ashland Chemicals. The zinc comprising precursor mix was then combusted in 99%+pure oxygen in the presence of argon-based DC thermal plasma in a reactor operating between about 0.1-0.75 atmospheres. The maximum feed velocity and gas processing velocities were above 0.1 mach and the peak processing temperatures were above 3000 K. The vapor was cooled to nucleate nanoparticles and then quenched using Joule Thompson effect as taught in co-owned U.S. Pat. No. 5,788,738. The powders were collected on a conductive polymer membrane filtration system. The collected powders were analyzed and were found to be pure zinc oxide and have a X-ray crystallite size less than 50 nanometers and a surface area greater than 20 m²/gm. The powder was examined under high resolution transmission electron microscope and was observed to be non-amorphous and it lacked artificially induced atomic disorder. The powder was post-processed using a classifier followed by thermal treatment below 300 C. for 1 hour in ambient air using a roller system operating at 37 Hz. A thermogravimetric study indicated that the particles had undetectable weight loss suggesting that the surface was clean. This example illustrates that surface-clean zinc oxide nanoparticles can be successfully prepared.

Zinc oxide nanoparticles are excellent additives for anti-itch and skin care formulations for pets. Zinc oxide nanoparticles can also provide expedited healing of wounds with antibacterial capabilities. Similarly, zinc oxide nanoparticles are effective source of zinc, an essential micronutrient mineral for pets. For use as a micronutrient for pets, the non-zinc impurities in the precursor raw materials need to be reduced to standards established in the art, such as the USP.

### EXAMPLE 4

### Titanium Oxide Nanoparticles

Tyzor® TOT titanium precursor (>99.5% purity) from DuPont was mixed with hexane from Ashland Chemicals. The titanium comprising precursor mix was then combusted in 99%+pure oxygen in the presence of argon-based DC thermal plasma in a reactor operating between about 0.2-0.85 atmospheres. The maximum feed velocity and gas processing velocities were above 0.2 mach and the peak processing temperatures were above 3000 K. The vapor was cooled to nucleate nanoparticles and then quenched using Joule Thompson effect as taught in co-owned U.S. Pat. No. 5,788,738. The powders were collected on a conductive polymer membrane filtration system. The collected powders were analyzed and were found to be pure titanium oxide (anatase) and have a X-ray crystallite size less than 50 nanometers and a surface area greater than 20 m²/gm. The powder was examined under high resolution transmission electron microscope and was observed to be nonamorphous, and it lacked atomic disorder. The powder was post-processed using a classifier followed by thermal treatment below 400 C. for 1 hour in ambient air using a roller kiln system operating at 18 Hz. A thermogravimetric study indicated that the particles had undetectable weight loss suggesting that the surface was clean. This example illustrates that surface-clean titanium oxide nanoparticles can be successfully prepared.

Titanium oxide nanoparticles so produced were dispersed in water without any dispersant yielding a pH less than 7 and conductivity less than 1000 microS/cm. The dispersion when dropped on a surface and then dried yields a white thin film/coating.

Titanium oxide is an excellent photocatalyst and can be utilized in the form of coating or additives to protect aquaculture equipment, reduce UV exposure to greenhouses, treat wood and fabric, and to reduce fogging of greenhouses.

### EXAMPLE 5

### Other Compositions

Using the process described in detail in above examples, calcium oxide was prepared from calcium Versalate® from Shepard Chemicals, iron oxide from iron octoate, magnesium oxide from magnesium acetate, manganese oxide from manganese Hex-Cem® and cobalt oxide from cobalt Hex-Cem® from OM Group. In all cases, the nanoparticles produced were characterized and found to be have an X-ray primary crystallite size of less than 60 nm from peak broadening analysis and BET surface area greater than 10 m²/gm. All of these compositions are important minerals and essential nutrients for pets and other fauna and flora.

It is preferred that other essential minerals such as K, Se, Na, P, vitamins and other actives be prepared in nanoparticle forms for benefits explained in detailed before.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

I claim:

1. An active ingredient for fauna and flora comprising nanoparticles.

2. The active ingredient of claim 1, wherein the nanoparticles comprise at least one essential nutrient.

3. The active ingredient of claim 2, wherein the at least one essential nutrient comprises an element selected from Cu, Zn, K, Ca, Fe, Mg, Mn, Co, and Na.

4. The active ingredient of claim 1, wherein the nanoparticles comprise at least one antimicrobial.

5. The active ingredient of claim 4, wherein the at least one antimicrobial comprises an element selected from Cu, Zn, and Ag.

6. The active ingredient of claim 1, wherein the nanoparticles comprise nanoparticles with sizes less than nano-solvation diameter.

7. The active ingredient of claim 6, wherein the nanoparticles comprise nanoparticles that lack artificially induced atomic disorder.

8. The active ingredient of claim 1, wherein the nanoparticles comprise at least one oxide.

9. The active ingredient of claim 1, wherein the nanoparticles comprise at least one metal.

10. The active ingredient of claim 1, wherein the nanoparticles comprise at least one drug.

11. The active ingredient of claim 1, wherein the nanoparticles are released over time.

12. A product comprising the active ingredient of claim 1.
